(19) United States
(12) Patent Application Publication
(10) Pub. No.: US 2020/0112155 A1
(43) Pub. Date: Apr. 9, 2020

(54) FLUSH MOUNTED ELECTRICAL FLOOR OUTLET

(71) Applicant: Jeffrey H. Smith, Southampton, NY (US)

(72) Inventor: Jeffrey H. Smith, Southampton, NY (US)

(21) Appl. No.: 16/155,682

(22) Filed: Oct. 9, 2018

(51) Int. Cl. H02G 3/08; H01R 25/00; H01R 13/447; H01R 13/52; H02G 3/12; H02G 3/14

(52) U.S. Cl. CPC H02G 3/088; H01R 25/006; H01R 13/447; H01R 24/76; H01R 13/5221; H02G 3/12; H02G 3/14; H01R 13/5213

(57) ABSTRACT

A flush mounted electrical floor outlet. The outlet includes a cover having a base plate, a first flap and a second flap which are pivotably coupled to the base plate and movable between a first position and a second position. Flexible gaskets are coupled to an edge of each of the two first flaps. An outlet housing is removably connected to the base plate. The outlet housing includes an opening for receiving an electrical outlet. A base plate gasket surrounds an inner edge portion of the base plate and is located between an upper surface of the base plate and a lower surface of each of the two flaps. In this manner, when the two flaps are in the closed position, the two edge gaskets form a seal between each other, and the base plate gasket forms a seal between the base plate and the two flaps.

### FIELD OF THE INVENTION

The present invention relates to a flush mounted electrical box for concealing an outlet or switch when surface mounted on a floor of a structure such as an office building or a residential building. It also relates to a system employing a flush mounted electrical box for concealing two (or more) outlets or switches as above.

The outlet or switch can be an electrical connector such as an electrical socket, a telephone or Ethernet cable socket, a switch or a push-button.

### BACKGROUND OF THE INVENTION

U.S. Pat. No. 6,887,088 describes a flush-mounted covering device for concealing an electric outlet or the like, in a surface of a floor of a building or installed in a wall. The device includes a plate in which a housing is formed, and a flap for closing the housing. The closing flap has, on its external surface, a handle that is connected to the flap by a hinge and is retractable in a recess formed along the edge of the flap.

The hinge of the handle allows the handle to be moved from a first position in which the handle lies flush with the floor or wall in which the device is mounted to second position in which the handle is perpendicular to the second position. In this manner, the handle is used to open the cover so that the electric outlet or the like can be easily accessed.

Its most common use is to conceal an electrical socket when the cover is closed. However, when in use, that is, when an electric plug is plugged into the socket, the wire which extends from the plug makes it impossible to fully close the cover. When the cover is partially open, in addition to creating a hazard since the raised cover can be tripped over by a person who does not see the open cover on the floor, water or other liquid spilled onto the floor can enter the opening and hit the electric socket inside the housing which can create an electrical hazard.

### BRIEF SUMMARY OF THE INVENTION

The present invention is directed to a flush mounted electrical box with one or two covers which can be lifted to expose one or two electrical sockets or switches inside the electrical box. Each cover has two flaps which open and close. Each flap has its own handle and a gasket on the edge of each flap. When a cover is opened by opening the two flaps (or at least one flap), the corresponding electrical socket or switch inside the electrical box can then be accessed. Each electrical socket is recessed below the surface, typically about 1.5 inches, to allow a user to insert a plug into the outlet and have enough room for the cover to close and a cord connected to the plug to run out between the two cover gaskets.

The covers and gaskets are arranged so that when, for example, the floor is mopped including the area in which the electrical box is located, essentially no liquid can pass through the closed covers into the electrical sockets. The one or two flush mounted electrical boxes are enclosed within a back box which is secured to a beam of other structural element to secure the electrical box in its position flush with the floor.

### BRIEF DESCRIPTION OF THE DRAWINGS

FIG. 1 is a perspective view showing the two outlet covers with the flaps closed according to the invention.

FIG. 2 is a perspective view showing the two outlet covers and two outlet housings with the flaps open.

FIG. 3A is a cross-section of FIG. 1 taken along line 3A-3A showing a single outlet cover with the flaps closed.

FIG. 3B is a cross-section of FIG. 2 taken along line 3B-3B showing a single outlet cover with the flaps closed.

FIG. 4 is an exploded view showing the relative positions of electrical sockets installed in a pair of outlet housings within a back box, each outlet housing having a corresponding cover with two flaps.

FIG. 5 is a bottom side perspective view of one outlet housing with an installed socket.

FIG. 6 is a perspective view showing a single outlet cover with its flaps closed according to the invention.

FIG. 7 is an exploded view showing the relative positions of an electrical socket installed in an outlet housing having a corresponding cover with one flap removed and a back box.

### DETAILED DESCRIPTION OF THE INVENTION

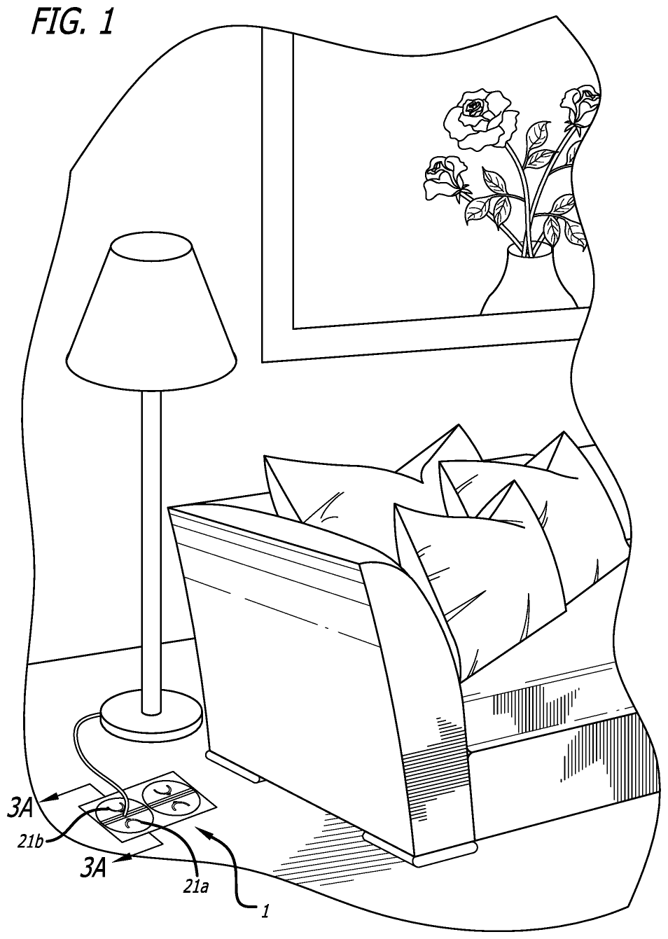

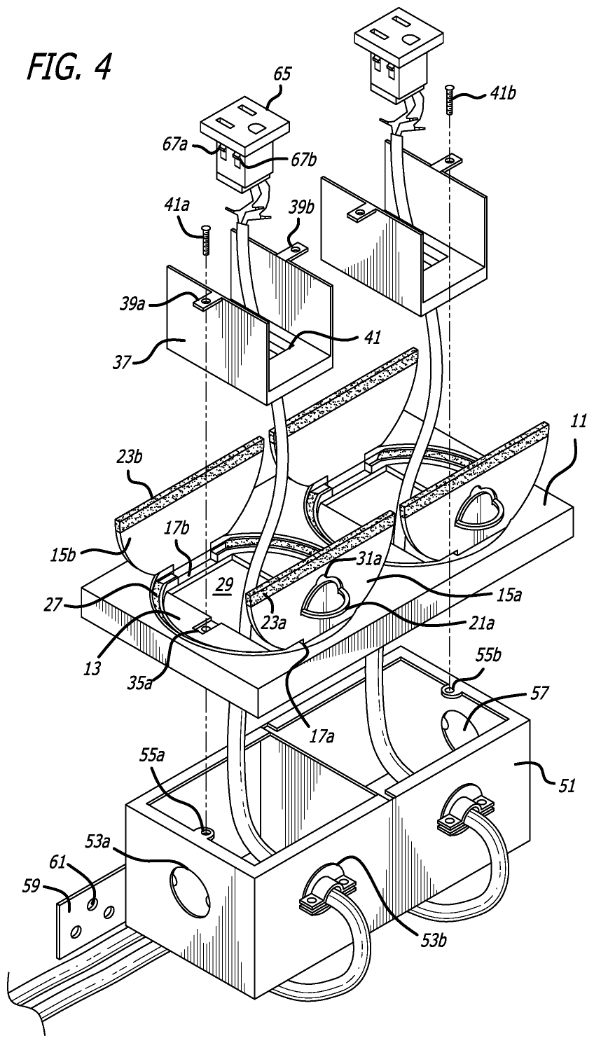

FIG. 1 illustrates a flush mounted electrical box 1 including a cover 11 and base plate 13 (shown in FIG. 4). Although shown in a closed position, as best seen in FIG. 4, the cover includes two flaps 15a and 15b, each including a corresponding flap handle 21a and 21b. Flap gaskets 23a and 23b are coupled to the edges of the two flaps. Not shown in FIG. 1 is outlet housing 37 which is shown in FIG. 4. Outlet housing 37 is removably coupled to the base plate to enable proper installation of the flush mounted electrical box.

Although FIG. 1 does not show an electrical socket or switch installed in outlet housing 37, it does show an electrical cable which has a plug (not shown) at a terminal end, the electrical cable extending between the two flap gaskets, with flaps 15a and 15b in the opened position. As shown in FIG. 1, the two flap gaskets form a seal around the cable which prevents water from seeping through the cover to an electrical socket or switch within the outlet housing.

In this manner, although water under pressure may possibly be able to penetrate the gaskets, in a typical environment, the only water which may reach the flush mounted electrical box would be water from a mop being used to wash the floor. In this manner, rather than having electrical outlets which sit on top of the floor, or are installed below the floor with an open cover as in the prior art, by use of the present invention, it is possible to obtain a flush mounted electrical box which lies flush with the floor and which provides protection against water seepage, even when a plug is connected to the electrical socket installed within the electrical box.

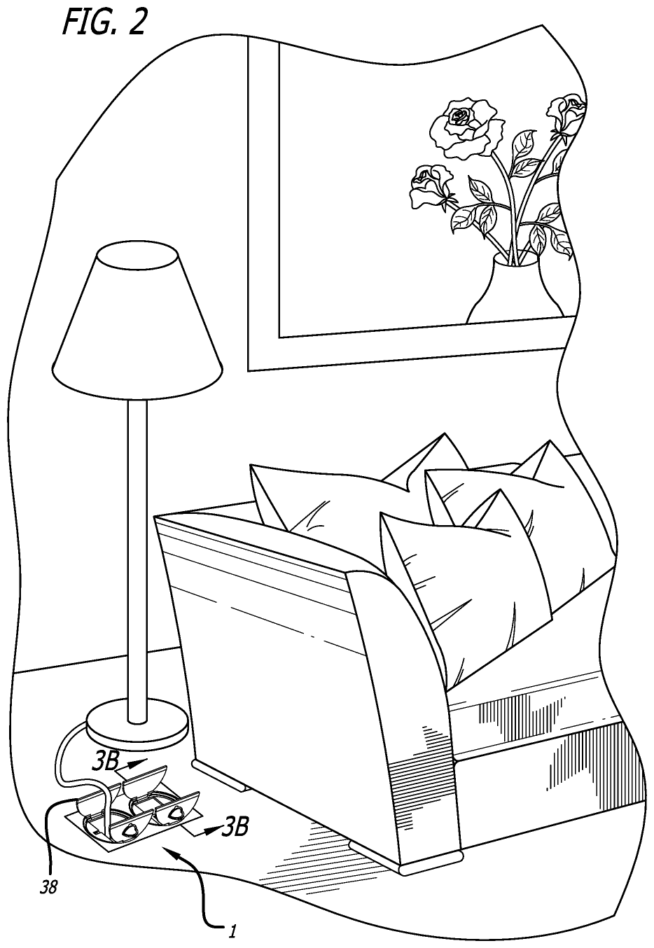

FIG. 2 shows flush mounted electrical box 1 with flaps 15a and 15b in the open position. As shown in FIG. 2, but as best seen in FIG. 4, the cover 11 includes base plate 13, hinges 17a and 17b and base plate gasket 27. Flaps 15a and 15b also include handles 21a and 22b. Handles 21a and 21b are used to open and close flaps 15a and 15b which rotate around hinges 17a and 17b. The specific structure of hinges 17a and 17b and how they connect to base plate 13 and flaps 15a and 15b are well known in the art and, therefore, will not be further described. Base plate gasket 27 is formed in two parts having a “C” shape and extend around a perimeter of base plate 13, contacting respective ends of hinges 17a and 17b. Base plate gasket 27 as well as flap gaskets 23a and 23b and are made of a flexible rubberized material of the type known in the art used to form seals for electrical outlets and the like.

When flaps 15a and 15b are in the open position, a plug may be inserted into an electrical socket as shown in FIG. 4 which is installed in outlet housing 37 which extends through base plate opening 29 as best seen in FIG. 4. Handles 21a and 21b are also movable from an open and closed position. In the closed position, the flaps and the handles lie flush with the top of cover 11 which, when installed within a floor, lies flush with the floor. Each flap includes a small indent 31a and 31b, respectively into which a finger may be inserted so that handles 21a and 21b may be lifted and then used to pull open flaps 15a and 15b.

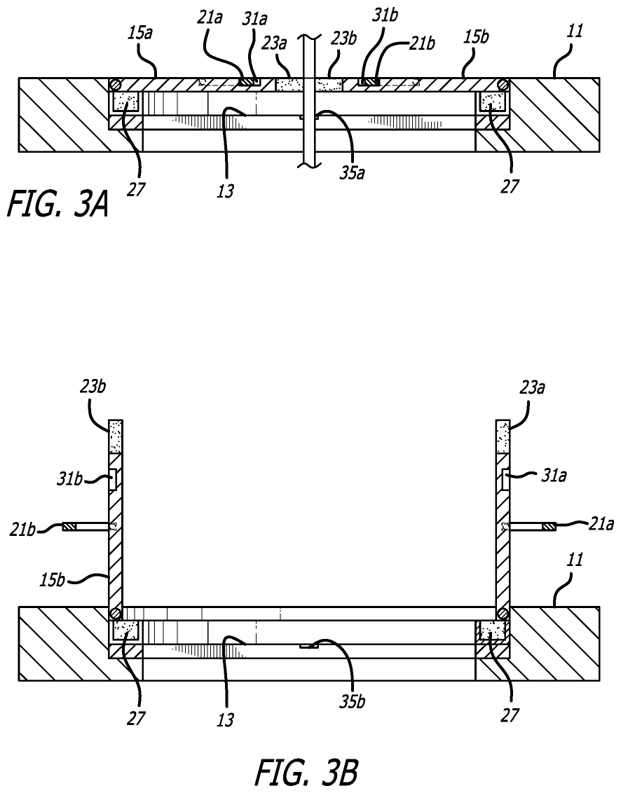

FIG. 3A shows a cross-section of cover 11 with flaps 15a and 15b in a closed position with and electrical cord or cable passing through gaskets 23a and 23b so that the gaskets form a seal between each other and the electrical cord or cable.

FIG. 3B shows a cross-section of cover 11 with flaps 15a and 15b in an open position with handles 21a and 21b in the open position pulled away from flaps 15a and 15b, respectively. As previously noted, handles 21a and 21b can be closed so they lie flush with the top of cover 11. FIG. 3B shows the arrangement of gasket 27 between each of flaps 15a and 15b and the top of plate 13. Since gasket 27 extends around the perimeter of base plate 13, when flaps 15a and 15b are closed as shown in FIG. 3A, gasket 27 forms a seal between the flaps and the base plate so that water on the surface of the cover will not seep through the sides of the flaps to the base plate and installed outlet housing 37.

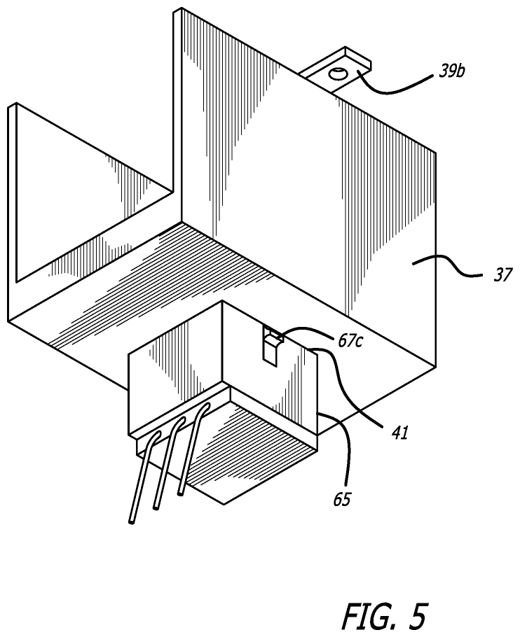

FIGS. 4-7 show an electric socket 65 of the type that may be installed in the invented flush mounted electrical box. Electrical socket 65 has electric socket locking latches 67a and 67b on one side and electric socket locking latch 67c on the opposite side as shown in FIG. 5. The electric socket shown in FIGS. 4-7 is a standard 120 volt socket for receiving a standard two prong plug with ground of the type in common use in the United States. However, the electric socket can be of any type such as the two pin type used in much of Europe or the three prong type used in the UK. The socket can also be of the form used for telephone wires or of the form used for Ethernet cables, or any other socket used for receiving a plug of any type. Instead of a socket, a switch such as a toggle or push-button switch may be installed in outlet housing 37 in which case there would be no wire extending between the two flap gaskets.

As shown in FIG. 4, flush mounted electrical box 1 is installed on back box 51. The back box includes access ports 53a and 53b. The access ports are normally closed or sealed, but can be opened to receive a wire or cable which passes through port into the back box so that it can be connected to a socket or switch installed in outlet housing 37. Normally, a single wire is used and depending on the direction of the wire coming into the back box, a seal 57, used to cover each access port, is easily removed in a manner well known in the art. Back box 51 includes flanges 55a and 55b with screw holes located on each flange formed on the top portion of the back box which line-up with screw holes in base plate recess 35a and 35b (not shown in FIG. 4) and screw holes in outlet housing connector flange 39a and 39b so that a single pair of screws 41a and 41b can be used to connect outlet housing 37 to cover 11 and cover 11 to back box 51. Back box 51 also includes back box flange 59 which extends from one side of the back box. A corresponding back box flange (not shown) extends from the other side of the back box. The two back box flanges include screw holes which are used to connect the back box to a floor beam or similar element so that the back box and flush mounted electrical box structure is securely connected to the floor in which the flush mounted electrical box is installed.

As best seen in FIG. 5, outlet housing 37 is generally “U” shaped with a flat bottom portion with opening 41. The bottom portion of outlet housing 37 extends below the top portion a distance which is sufficient to enable a plug when received by a socket installed in the outlet housing to lie sufficiently below the flaps when in a closed position so that the flaps can lie flush with cover 11 with only a cable or cord from the plug extending through the flap gaskets of the closed flaps as shown in FIG. 1. Side walls of the outlet housing extend perpendicular from the flat bottom and parallel to each other. The top of each of the side walls includes outlet housing connector flanges 39a and 39b, each including a screw hole as best seen in FIG. 4. The two connector flanges extend perpendicular and outwardly from each of the two side walls.

Socket locking latches 67a, 67b and 67c of socket 65 are shaped so that when socket 65 is pushed through opening 41, the pressure from the edges of opening 41 forces the locking latches into the socket and when the pressure is released, they pop out so as to lock socket 65 in place in housing 37. That is, when socket 65 is inserted into the outlet housing and the latches return to their original position, the socket is effectively locked into place within the outlet housing. In this manner, when a plug is pushed into the socket and then removed, the removal of the plug from the socket will not result in the socket being removed from the outlet housing. The specifics of the mechanism used to maintain the socket in the outlet housing are not important to an understanding of the invention and any suitable mechanism such as glue or screws which operate to keep the socket in the outlet housing when a plug is removed may be used.

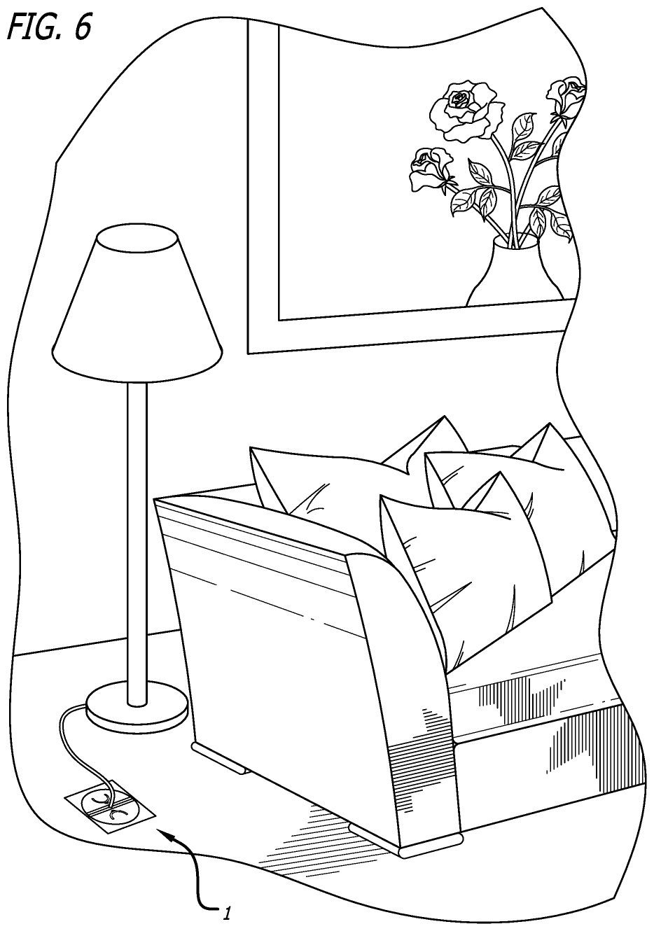

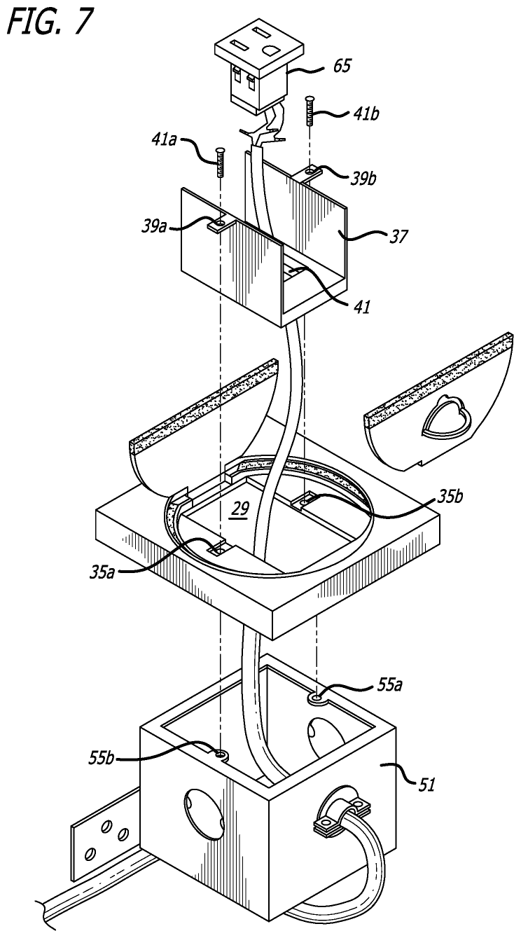

FIGS. 6 and 7 show an embodiment having a single base plate and outlet housing for a single electrical socket. Outlet housing 37 is installed by screws extending through respective screw holes in outlet housing connector flanges 39a and 39b which are received by corresponding screw holes in base plate recess 35a and 35b. Outlet housing 37 includes an opening 41 as shown in FIG. 7 for receiving an electrical socket 65 as explained above with reference to FIG. 4.

In embodiments in which there is only one electrical outlet as shown in FIGS. 6 and 7, the second screw hole 55b is located on a flange opposite the flange in which screw hole 55a is located. That is, back box 51 instead of having two spaces for receiving two outlet housings, has a single space for a single outlet housing.

Accordingly, a flush mounted electrical box has been shown and described. Although various details and embodiments have been disclosed, the invention is defined with reference to the following claims.

1. A flush mounted electrical floor outlet comprising:
a) a cover including a base plate, a first flap and a second flap, each said flap pivotably coupled to said base plate and movable between a first position in which said flaps are in a same plane and a second position in which said flaps are substantially parallel to each other;
b) a flexible first gasket coupled to an edge of said first flap;
c) a flexible second gasket coupled to an edge of said second flap;
d) an outlet housing removably connected to said base plate;
e) said outlet housing including an opening for receiving an electrical outlet;
f) a base plate gasket surrounding an inner edge portion of said base plate on an upper surface of said base plate between an upper surface of said base plate;
wherein when said first flap and said second flap are in said first position, said first gasket and said second gasket contact each other to form a seal, and said base plate gasket forms a seal between said base plate and said first and second flaps.

2. The electrical floor outlet defined by claim 1 further comprising a first hinge coupled to a second edge of said first flap and said base plate and a second hinge coupled to a second edge of said second flap and said base plate, said first and second hinges enabling said first and second flaps to be pivotably coupled to said base plate.

3. The electrical floor outlet defined by claim 1 further comprising a first handle pivotably connected to an upper surface of said first flap and a second handle pivotably connected to an upper surface of said second flap, wherein said first handle and said second handle in a first position lie flush with said upper surface of said first flap and said second flap, respectively, and in a second position, are substantially parallel to said upper surface of said first flap and said second flap, respectively.

4. The electrical floor outlet defined by claim 1 wherein said outlet housing has a flat bottom portion which includes an opening and two parallel side wall portions extending from said bottom portion, each of said side wall portions including a fastening flange which extends outwardly from a respective one of said side wall portions.

5. The electrical outlet defined by claim 4 wherein said base plate includes first and second recessed portions configured to receive a corresponding one of said fastening flanges, and said recessed portions and fastening flanges are configured to enable said outlet housing to be coupled to said base plate.

6. The electrical outlet defined by claim 1 wherein said cover and said base plate form an integral unit.

7. The electrical outlet defined by claim 1 wherein said outlet housing opening is configured to receive an electrical outlet.

8. The electrical outlet defined by claim 1 wherein said outlet housing opening is configured to receive an electrical switch.

9. The electrical outlet defined by claim 1 wherein said base plate forms a generally circular shaped opening in said cover and said flaps are configured to be received by said circular shaped opening so that when said flaps are in said first position, said seals formed by said first and second edge gaskets and said base plate gasket is sufficient to substantially prevent water or other liquid from entering said outlet housing.

10. A flush mounted electrical floor outlet comprising:
a) a cover including a base plate, a pair of first flaps and a pair of second flaps, each said flap pivotably coupled to said base plate and movable between a first position in which said flaps are in a same plane and a second position in which said flaps are substantially parallel to each other;
b) a pair of flexible first gaskets coupled to an edge of each said first flap;
c) a pair of flexible second gaskets coupled to an edge of each said second flap;
d) a pair of outlet housings removably connected to said base plate;
e) each said outlet housing including an opening for receiving an electrical outlet;
f) a pair of base plate gaskets surrounding an inner edge portion of said base plate disposed between an upper surface of said base plate and a lower surface of each said first flap and a lower surface of each said second flap;
wherein when each of said first flaps and each of said second flaps are in said first position, each said first gasket and each said corresponding second gasket contact each other to form a seal, and each said base plate gasket forms a seal between said base plate and each of said first and second flaps.

11. The electrical outlet defined by claim 10 wherein each said base plate forms a generally circular shaped opening in said cover and said first flaps and each of said second flaps are configured to be received by a respective one of said circular shaped openings so that when said flaps are in said first position, said seals formed by said first and second edge gaskets and said base plate gaskets are sufficient to substantially prevent water or other liquid from entering said outlet housings.
